(19) United States
(12) Patent Application Publication
(10) Pub. No.: US 2024/0355315 A1
(43) Pub. Date: Oct. 24, 2024

(54) METHOD FOR EVALUATING THE SAMENESS OF AN AURALIZATION

(71) Applicant: Robert Bosch GmbH, Stuttgart (DE)

(72) Inventors: Andreas Henke, Ditzingen (DE); Hannes Muench, Wuerzburg (DE); Jan Herrmann, Waiblingen (DE); Marcus Biehler, Wuestenrot (DE); Michael Benk, Heubach (DE); Robertus Opdam, Wuestenrot (DE); Stefanos Kapetanidis, Stuttgart (DE); Thomas Wagner, Bad Liebenzell (DE)

(21) Appl. No.: 18/438,792

(22) Filed: Feb. 12, 2024

(30) Foreign Application Priority Data
Apr. 20, 2023 (DE) 10 2023 203 620.7

(51) Int. Cl. G10K 15/02

(52) U.S. Cl. CPC G10K 15/02

(57) ABSTRACT

A method for evaluating the sameness of an auralization. The method including: providing a synthesis signal to map a real acoustic signal of a device; providing a reference signal that results from a reference measurement of a real acoustic signal of a device; evaluating the sameness between the provided synthesis signal and the provided reference signal to obtain a sameness result for the auralization, wherein the evaluation is carried out on the basis of an evaluation model for sameness according to human perception; providing the sameness result; wherein the evaluation of the sameness is carried out for at least two modifications of the provided synthesis signal in order to separately evaluate at least one frequency component of the synthesis signal.

### CROSS REFERENCE

The present application claims the benefit under 35 U.S.C. § 119 of German Patent Application No. DE 10 2023 203 620.7 filed on Apr. 20, 2023, which is expressly incorporated herein by reference in its entirety.

### FIELD

The present invention relates to a method for evaluating the sameness of an auralization. The present invention also relates to a computer program, a device and a storage medium for this purpose.

### BACKGROUND INFORMATION

A method for carrying out echo cancellation, in which a far-end signal is received and a microphone signal is recorded at the near-end device, is described in U.S. Patent Application No. US 2020/0411030 A1. A recurrent neural network is provided, which is configured such that it calculates estimated echo features based on the far-end features.

Perceptual Evaluation of Speech Quality (PESQ) is a conventional method for evaluating the speech quality of communication systems such as telephones, cell phones, and Voice over Internet Protocol (VOIP) systems. This is an objective measurement method that uses an algorithm to compare the transmitted and received speech signals and generate a value that represents the perceived quality of the received speech signal.

### SUMMARY

The present invention is a method for evaluating the sameness of an auralization, a computer program, a device, and a computer-readable storage medium. Further features and details of the present invention will emerge from the disclosure herein. Features and details which are described in connection with the method according to the present invention will of course also apply in connection with the computer program according to the present invention, the device according to the present invention and the computer-readable storage medium according to the present invention and vice versa, so that mutual reference is or can always be made with respect to the disclosure of the individual aspects of the present invention.

According to an example embodiment of the present invention, a method for evaluating the sameness of an auralization, comprises the following steps which are preferably carried out successively and/or repeatedly:
providing a synthesis signal to map, preferably simulate, a real acoustic signal of a device, preferably by means of auralization, wherein the synthesis signal is preferably provided in the form of digital data,
providing a reference signal that results from a reference measurement of a or the real acoustic signal of a or the device, wherein the reference signal is preferably provided in the form of digital data,
evaluating the sameness between the provided synthesis signal and the provided reference signal to obtain a sameness result for the auralization wherein the evaluation is preferably based on an evaluation model for sameness according to human perception, wherein the sameness result preferably quantifies the quality of the auralization,
providing the sameness result, preferably via a digital output of the sameness result.

According to an example embodiment of the present invention, it can be provided that the evaluation of the sameness is carried out for at least two modifications of the provided synthesis signal in order to separately evaluate at least one frequency component of the synthesis signal. In other words, the evaluation of the sameness between the provided synthesis signal and the provided reference signal can in particular be carried out at least in part by evaluating the sameness between the at least two modifications of the provided synthesis signal, i.e., modified synthesis signals, and the provided reference signal. The method according to the present invention thus provides an improvement over traditional evaluation methods for synthetic acoustic signals and can in particular also have the ability to quantify the auralization quality. A machine learning model, for instance, hereinafter also referred to briefly as an ML model, can be used as the evaluation model, and, based on training data and an evaluation thereof with the aid of Jury tests, can learn the ability to compare acoustic signals among one another and evaluate them according to their sameness. The sameness can refer to the extent to which two or more signals are identical or similar, for example in terms of amplitude and phase in the frequency spectrum and/or the amplitude in the time domain.

According to an example embodiment of the present invention, the sameness result can advantageously also be used to quantify the auralization quality. The sameness result in particular provides a deterministic quality criterion for the auralization of synthetic acoustic signals. The quality criterion can provide objective validation based on single number values that can be calculated using an ML model that is trained subjectively according to human perception.

The auralization quality can refer to the accuracy and realism of the sound produced by an auralization. Auralization can refer to a computer-aided synthesis, in particular simulation, of acoustic signals, such as sound sources and their propagation in a space or an environment. Auralizations can be used to simulate how a sound propagates in a space or environment, how it is reflected or absorbed by different materials, and how it can be heard from different positions in the space or environment. The present invention in particular describes a deterministic quality criterion for the auralization of synthetic acoustic signals. The synthesis signal, for example, can be provided by auralization.

The present invention can have the advantage that the evaluation answers quality-related questions, such as: What accuracy is required in the objective validation of Fourier transformed (FFT) spectra to achieve an equivalent auditory impression between the synthesis and the reference measurement? What impact do selected frequency components of the synthesis have on the auralization and thus make a significant contribution to achieving an equivalent auditory impression between the synthesis and the reference measurement?

The reference signal can result from a reference measurement of a real acoustic signal, for instance, if a measurement has been carried out on the real device in preparation for the evaluation, in particular during operation of the device. The device is a heat pump, for example, which emits a sound that may subjectively be perceived as disturbing during operation. The auralization and in particular the evaluation can be used to optimize the acoustic emission of the device.

The present invention can also provide an objective deterministic quality criterion for the auralization of synthetic acoustic signals. The use of an ML model that is trained subjectively according to human perception and an objective single number output value can also make it possible to combine and improve traditional validation concepts in order to enable the quantification of the auralization of synthetic acoustic signals. The present invention makes it possible to deduce the required accuracy for an equivalent auditory impression between the synthesis and the reference measurement. The quality criterion can moreover be automated to facilitate evaluation.

According to an example embodiment of the present invention, it can be advantageous if, in the context of the present invention, the modifications include a modification of at least one parameter in the frequency or time domain, in particular a sound pressure and/or the phase position of the sound pressure, of the provided synthesis signal such that this parameter is aligned with the reference signal for at least a part of a frequency range of the provided synthesis signal. The alignment can include an approximation to the corresponding parameter of the reference signal, for instance. The modifications can include sound pressure- and/or phase-modified syntheses of the synthesis signal, for example. The sound pressure and/or phase modified syntheses can be used to evaluate the influence of selected frequency ranges on the auralization. The generation of modified syntheses, i.e., the modified synthesis signals, can be automated and the frequency ranges can be subdivided as desired (e.g. octave bands or third octave bands). The output of the evaluation and preferably ML model can include a single number value or multiple single number values and can be an objective indicator of the sameness evaluation based on a plurality of subjective evaluations. Sound pressure measurement data of the system to be examined, for which evaluations from listening tests are available, for example, can be used as training data for the ML model.

For instance, at least three or at least four or at least six or at least ten modifications per provided synthesis signal can be carried out to separately evaluate (at least two or at least three or at least five or at least nine) different frequency components of the synthesis signal. A respective number of modified synthesis signals can be obtained, in which the alignment has taken place as a function of the different frequency components.

According to an example embodiment of the present invention, it is further optionally provided that, in a first of the modifications, the provided synthesis signal is aligned with the reference signal for an entire frequency range in order to obtain a comparison evaluation. It can also be possible that, in at least a second and/or further of the modifications, the provided synthesis signal is aligned with the reference signal for the entire frequency range in the same manner with the exception of a portion of the entire frequency range in order to separately evaluate the respective (excepted or non-aligned) portion as the frequency component of the provided synthesis signal. This is based on the idea that the aligned frequency ranges are thus masked, because they are substantially tonally aligned with the reference signal. The evaluation of the auralization quality can thus be focused on the portion excluded in the alignment.

It is also possible that at least a first modified synthesis signal and a second modified synthesis signal and preferably even more modified synthesis signals are obtained based on the modifications, wherein at least the first and second, and in particular the further modified synthesis signal(s) and at least the reference signal can be used as inputs for the evaluation model, preferably in the time domain. The individual modified synthesis signals can therefore be evaluated, if necessary also sequentially, with regard to their sameness with the reference signal and the influence of the individual frequency components to be evaluated on the auralization quality can consequently be determined as well.

In the context of the present invention, it is also possible that, for the evaluation of the sameness between the provided synthesis signal and the provided reference signal, the following step is carried out in each case for the frequency components to be evaluated separately:
carrying out a partial evaluation of the sameness between the provided reference signal and the provided synthesis signal, limited to the respective frequency component, in order to obtain a respective partial sameness result,
   wherein the partial sameness results can be compared to one another to obtain the sameness result. The sameness can therefore also be evaluated indirectly. In principle, an indirect and/or a direct sameness formulation can be used. In the indirect sameness formulation, a single number output value of the evaluation and preferably ML model can describe how well the synthesis and the reference measurement are perceived and evaluated; but in particular without information content regarding the sameness of the acoustic signals. Sameness between the synthesis and the reference measurement exists in particular when the single number output value between the reference measurement and the (in particular sound pressure) modified synthesis of all discretized frequencies to be evaluated is identical. In the direct ML sameness formulation, the single number output value of the model can describe directly whether there is sameness between the pairwise comparison synthesis and the reference measurement.

It is also advantageous if, in the context of the present invention, the evaluation model, preferably in the form of a machine learning model, is designed and in particular trained to evaluate how the sameness according to human perception would be evaluated in an automated manner, wherein the machine learning model was preferably trained for this purpose with training data that includes (in particular sound pressure) measurement data of the device and/or associated evaluation results from human listening tests. The evaluation can therefore be based on a variety of subjective evaluations. The trained ML model can, for instance, be formulated with a regression problem based on pairwise comparisons of signals to evaluate the predicted differences of all the pairs being considered. The ML model can furthermore be formulated in such a way that it can evaluate selected quality variables. One idea of the present invention is based in particular on the use of an ML model that is trained subjectively according to human perception to evaluate the sameness between the auralized synthesis and the reference measurement. The ML model can be formulated in such a way that the sameness is evaluated indirectly and directly. The input data of the model can be the reference measurement, the synthesis and the sound pressure-modified synthesis of selected frequency ranges of the synthesis signal.

In the context of the present invention, it can also be provided that the evaluation model carries out the evaluation on the basis of a subjective evaluation scheme, which includes a human classification of acoustic and synthesized signals with respect to sound quality. In other words, the evaluation can be carried out not using objective criteria but using subjective criteria, e.g., using machine learning. However, instead of carrying out actual jury tests, an automated evaluation can be provided.

The present invention also relates to a computer program, in particular a computer program product, comprising instructions that, when the computer program is executed by a computer, prompt said computer program to carry out the method according to the present invention. The computer program according to the present invention thus brings with it the same advantages as have been described in detail with reference to a method according to the present invention.

The present invention also relates to a device for data processing which is configured to carry out the method according to the present invention. The device can be a computer, for example, that executes the computer program according to the present invention. The computer can comprise at least one processor for executing the computer program. A non-volatile data memory can be provided as well, in which the computer program can be stored and from which the computer program can be read by the processor for execution.

The present invention can also relate to a computer-readable storage medium, which comprises the computer program according to the present invention and/or instructions that, when executed by a computer, prompt said computer program to carry out the method according to the present invention. The storage medium is configured as a data memory such as a hard drive and/or a non-volatile memory and/or a memory card, for example. The storage medium can, for instance, be integrated in the computer.

The method according to the present invention can moreover also be configured as a computer-implemented method.

Further advantages, features and details of the present invention will emerge from the following description, in which embodiment examples of the present invention are described in detail with reference to the figures. The features mentioned herein can each be essential to the present invention individually or in any combination.

### BRIEF DESCRIPTION OF THE DRAWINGS

FIG. 1 shows a schematic visualization of a method, a device, a storage medium and a computer program according to embodiment examples of the present invention.

FIG. 2 shows another schematic illustration of embodiment examples of the present invention.

FIG. 3 shows a schematic illustration of modifications.

### DETAILED DESCRIPTION OF EXAMPLE EMBODIMENTS

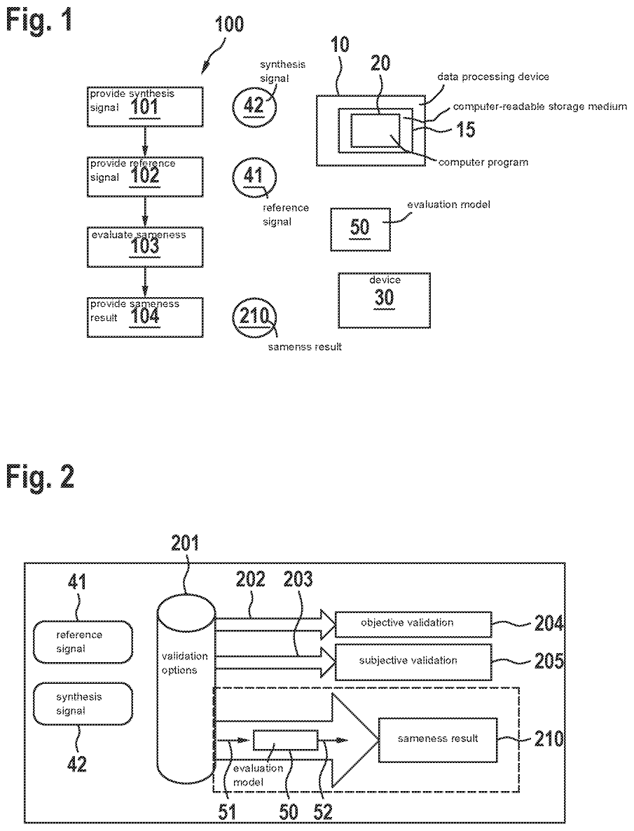

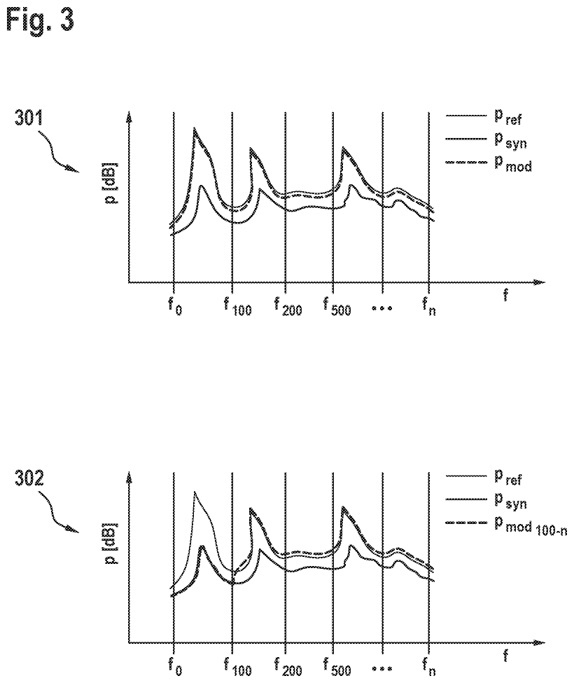

FIG. 1 schematically shows a method 100, a data processing device 10, a storage medium 15 and a computer program 20 according to embodiment examples of the present invention. The method 100 is used for evaluating the sameness of an auralization in which a synthesis signal 42 is provided according to a first method step 101. A real acoustic signal of a device 30, such as a heat pump, can thus be mapped, in particular in the sense of simulating the signal. According to a second method step 102, a reference signal 41 that results from a reference measurement of a or the real acoustic signal of a or the device 30 can be used. For this purpose, a real measurement can be carried out on the device 30 in preparation for the evaluation. According to a third method step 103, the evaluation of the sameness between the provided synthesis signal 42 and the provided reference signal 41 can then be carried out to obtain a sameness result 210 for auralization. The evaluation 103 can be carried out based on an evaluation model 50 for sameness according to human perception. According to a fourth method step 104, the sameness result 210 can then be provided, e.g. output, (see also FIG. 2). The evaluation 103 of the sameness can be carried out for at least two modifications 301, 302 of the provided synthesis signal 42 in order to separately evaluate at least one frequency component f of the synthesis signal 42 (see FIG. 3).

According to FIG. 3, the modifications 301, 302 can include a modification of at least one parameter, in particular a sound pressure and/or the phase position of the sound pressure, of the provided synthesis signal 42 such that this parameter is aligned with the reference signal 41 for at least a part of a frequency range of the provided synthesis signal 42. In a first 301 of the modifications 301, 302, the provided synthesis signal 42 can be aligned with the reference signal 41 for an entire frequency range f₀-fₙ in order to obtain a comparison evaluation. Furthermore, in at least a second 302 and/or further of the modifications 301, 302, the provided synthesis signal 42 can be aligned with the reference signal 41 for the entire frequency range f₀-fₙ in the same manner with the exception of a portion (e.g. f₀-f₁₀₀) of the entire frequency range f₀-fₙ in order to separately evaluate the respective portion as the frequency component of the provided synthesis signal 42. This excepted portion is shown as an example in FIG. 3 for 302 between f₀ and f₁₀₀. This is then the frequency component f, which can be evaluated separately. As an example, FIG. 3 shows the reference signal 41 as p_{ref}, the provided (unmodified) synthesis signal 42 as p_{syn} and the modified synthesis signals as p_{mod} and p_{mod100-n}, wherein p_{mod} shows the alignment for the entire frequency range and p_{mod100-n} shows the alignment for the frequency range f₁₀₀-fₙ, for example. Thus, based on the modifications 301, 302, at least a first modified synthesis signal p_{mod} and a second modified synthesis signal p_{mod100-n} are obtained. Also, at least the first and the second modified synthesis signal p_{mod}, p_{mod100-n} and at least the reference signal 41 can be used as inputs for the evaluation model 50, wherein the inputs are preferably provided in the time domain.

The evaluation model 50 can be provided in the form of a machine learning model 50. The ML model 50 can have been trained to evaluate how the sameness according to human perception would be evaluated in an automated manner. It is therefore possible that the evaluation model 50 carries out the evaluation 103 on the basis of a subjective evaluation scheme which includes a human classification of acoustic and synthesized signals with respect to sound quality. The method 100 according to embodiment examples of the present invention thus has clear advantages over traditional solutions. Experimental, numerical or hybrid methods, such as those found in a transfer path analysis (TPA) or finite element method (FEM), can in principle be used to predict the emitted sound pressure of a system such as the device 30 for an examined spatial position. This synthetic acoustic signal 42 can be described in either the time or the frequency domain. The sound pressure is the physical quantity that makes auralization, i.e. the audibilization of the acoustic signal 41, possible. To quantify the quality of the auralization, the synthesis can be validated using a reference measurement that maps the noise of the product to be examined, such as the device 30, under real conditions. One example of a traditional validation concept for the auralization of synthetic acoustic signals 42 is objective validation 204 with frequency spectra using a fast Fourier transformation (FFT) of sound pressure and possibly psychoacoustic quantities (see FIG. 2). As an alternative to this, a traditional subjective validation 205 of synthetic acoustic signals 42 on the basis of auralized acoustic signals 41 can be used. The FFT spectra are simply an indicator of how high the auralization quality will be and how selected frequency components influence the auralization. However, objective validation 204 does not provide an exact measure of the auralization quality. It does not provide any information about what deviation between the synthetic and the real signal is still perceived as realistic or plausible by a listener or at what point a difference in the spectrum also leads to a difference in perception. A subjective validation 205, on the other hand, is always dependent on human perception and is therefore not able to ensure an independent quantification of the auralization quality. Consequently, neither option is a deterministic quality criterion.

Embodiment examples of the present invention can be used on a heat pump 30. Sufficient training data for the ML model 50 can initially be provided as auralized sound pressure measurement data in WAV or MP3 format, for example. The training data can thus result from the acquisition of a variety of measurement data that depict the operating behavior of heat pumps 30. A synthesis in airborne sound can then be calculated using a TPA method (e.g. in situ ISO 20270). TPA stands for “transfer path analysis” and is a method for analyzing sound and vibration transmission in a multielement system. The syntheses can then be processed and modified for evaluation in the ML model 50 (input data). This makes it possible to quantify the sameness of the reference measurement and the synthesis using single number values 52 from the ML model 50 (output 52, see FIG. 2). The evaluation of necessary steps can be provided in the TPA model 50 to improve the auralization quality if it is inadequate.

For the sameness evaluation, it can be provided that the existing frequency component in the synthesis and the reference measurement is identical. The frequency range of the reference measurement can therefore be adapted to the synthesis via a high and low-pass filter, if necessary. It can optionally also be provided that all dominant transfer paths, such as structure-borne sound, direct airborne sound and fluid-borne sound, are included in the synthesis in order to describe the sound pressure correctly.

FIG. 2 shows an example of a validation process for the auralization of synthetic acoustic signals 42. An acoustic signal 41 can be provided as a reference measurement. A synthetic acoustic signal 42 can be provided as well and obtained by means of experimental, numerical or hybrid methods, for instance. FFT spectra 202 and an auralization 203, which can be used for objective validation 204 (of the sound pressure in the frequency domain using the FFT spectra 202) and for subjective validation 205 (of the sound pressure via human perception in the time domain), can then be obtained on the basis of the validation options 201. Embodiment examples of the present invention can extend this process by using time data 51 of the synthesis signal 42 as the input 51 for the evaluation model 50, preferably ML model 50, and obtaining a single number value 52 for the sameness evaluation as the output 52 for the model 50. An objective validation 210 using the subjectively trained ML model 50 can thus be enabled.

The quality criterion for the auralization for validating 210 synthetic acoustic signals 42 can be provided with a plurality of steps, as shown with further details in FIG. 3. According to a first step, a processing and modification of the sound pressure spectra in the frequency domain for the evaluation can be provided in the evaluation model 50, preferably ML model 50. A first objective validation 210 of the synthesized sound pressure spectra can be carried out with the reference measurement. An automated modification of the synthesis can furthermore be provided for the entire discretized frequency range with FIR filter x(fₙ), so that the modified synthesis corresponds to that of the reference. The modification can be necessary for the validation 210 of the direct and indirect sameness evaluation. An automated modification of selected frequency ranges in the synthesis with FIR filter x(fₙ) can be provided as well. This makes it possible to evaluate the influence of the non-modified (i.e. non-aligned) frequency range on the auralization. For instance, a pairwise comparison of the reference and the modified synthesis p_{mod100-n} can be used to evaluate whether there is any influence and how high said influence for the frequency range 0<f<100 is on the auralization. The frequency range can then be subdivided as desired to examine zones of influence, e.g. in octave or third octave bands. An auralization of the reference, non-modified synthesis and all modified synthesis spectra can then be carried out. This enables a conversion from frequency domain to time domain by means of cyclic or non-cyclic convolution. The data can then be stored in WAV or MP3 format, for example. The automatic modification is visualized in FIG. 3, wherein the reference signal 41 P_{ref} and the synthesized signal p_{syn} as well as the modified synthesis P_{mod} are shown against the sound pressure p (in dB) and the frequency f (in Hz).

According to a second step, input data for the model 50 can be the reference, the non-modified synthesis, and the modified synthesis in WAV or MP3 format. A direct sameness evaluation can, for instance, be carried out as follows: A trained ML model 50 that directly evaluates the sameness of acoustic signals 41 in a pairwise comparison is used. A pairwise comparison between the respective reference and non-modified/modified synthesis is carried out as well. It is also possible that an indirect sameness evaluation is used as follows: A trained ML model 50 that indirectly evaluates the sameness of acoustic signals 41 is used. The ML model 50 evaluates how good the sound sounds. This means that it is not possible to directly deduce whether the acoustic signals 41 sound the same. An identical evaluation of the reference measurement and the modified synthesis for all discretized frequencies fₙ mit n∈[0,n] ultimately corresponds to a sameness of the signals.

According to a third step, an evaluation of the single number output values of the model 50 and a quantification of the auralization quality can be carried out. For the direct sameness evaluation, an evaluation of the sameness in the pairwise comparison of reference/non-modified synthesis and/or in the pairwise comparison of reference/modified synthesis (all discretized frequencies), in particular by means of a validation 210 of the ML model evaluation and/or in the pairwise comparison of reference/modified synthesis (selected frequency ranges), in particular by evaluating the influence of frequency ranges on the auralization can be carried out. For the indirect sameness evaluation, an evaluation of the single number value 52 of the reference and the modified synthesis can be carried out for all discretized frequencies, wherein an identical value corresponds to sameness, or for selected frequency ranges, wherein a deviation of the single number value 52 is an indicator of non-sameness. Sameness is achieved in particular when the single number value 52 and the sound pressure level of the reference and the synthesis are identical.

The above explanation of the example embodiments describes the present invention solely within the scope of examples. Of course, individual features of the embodiments of the present invention can be freely combined with one another, if technically feasible, without leaving the scope of the present invention.

What is claimed is:

1. A method for evaluating sameness of an auralization, comprising the following steps:
providing a synthesis signal to map a real acoustic signal of a device;
providing a reference signal that results from a reference measurement of the real acoustic signal of the device;
evaluating the sameness between the provided synthesis signal and the provided reference signal to obtain a sameness result for the auralization, wherein the evaluation is carried out based on an evaluation model for sameness according to human perception; and
providing the sameness result, wherein the evaluation of the sameness is carried out for at least two modifications of the provided synthesis signal to separately evaluate at least one frequency component of the synthesis signal.

2. The method according to claim 1, wherein the modifications include a modification of at least one parameter in the frequency or time domain including a sound pressure and/or a phase position of the sound pressure, of the provided synthesis signal, such that the parameter is aligned with the reference signal for at least a part of a frequency range of the provided synthesis signal.

3. The method according to claim 1, wherein:
in a first modification of the modifications, the provided synthesis signal is aligned with the reference signal for an entire frequency range to obtain a comparison evaluation and, in at least a second modification and/or further modification of the modifications), the provided synthesis signal is aligned with the reference signal for the entire frequency range in the same manner with the exception of a portion of the entire frequency range to separately evaluate the respective non-aligned portion as the frequency component of the provided synthesis signal.

4. The method according to claim 1, wherein, based on the modifications, at least a first modified synthesis signal and a second modified synthesis signal are obtained, wherein at least the first modified synthesis signal and the second modified synthesis signal and at least the reference signal are used as inputs for the evaluation model, wherein the inputs are provided in a time domain.

5. The method according to claim 1, wherein, for the evaluation of the sameness between the provided synthesis signal and the provided reference signal, the following step is carried out for each of the frequency components to be evaluated separately:
carrying out a partial evaluation of the sameness between the provided reference signal and the provided synthesis signal limited to the respective frequency component to obtain a respective partial sameness result;
wherein the partial sameness results are compared with one another to obtain the sameness result.

6. The method according to claim 1, wherein the evaluation model is a machine learning model and is configured and trained to evaluate how the sameness according to human perception would be evaluated in an automated manner, wherein the machine learning model is trained with training data that includes sound pressure measurement data of the device and/or associated evaluation results from human hearing tests.

7. The method according to claim 1, wherein the evaluation model carries out the evaluation based on a subjective evaluation scheme which includes a human classification of acoustic and synthesized signals with respect to sound quality.

8. A device for data processing, the device configured to evaluate sameness of an auralization, the device configured to:
provide a synthesis signal to map a real acoustic signal of a device;
provide a reference signal that results from a reference measurement of the real acoustic signal of the device;
evaluate the sameness between the provided synthesis signal and the provided reference signal to obtain a sameness result for the auralization, wherein the evaluation is carried out based on an evaluation model for sameness according to human perception; and
provide the sameness result, wherein the evaluation of the sameness is carried out for at least two modifications of the provided synthesis signal to separately evaluate at least one frequency component of the synthesis signal.

9. A non-transitory computer-readable storage medium on which are stored instructions for evaluating sameness of an auralization, the instructions, when executed by a computer, causing the computer to perform the following steps:
providing a synthesis signal to map a real acoustic signal of a device;
providing a reference signal that results from a reference measurement of the real acoustic signal of the device;
evaluating the sameness between the provided synthesis signal and the provided reference signal to obtain a sameness result for the auralization, wherein the evaluation is carried out based on an evaluation model for sameness according to human perception; and
providing the sameness result, wherein the evaluation of the sameness is carried out for at least two modifications of the provided synthesis signal to separately evaluate at least one frequency component of the synthesis signal.
